(19) United States
(12) Patent Application Publication
(10) Pub. No.: US 2020/0334108 A1
(43) Pub. Date: Oct. 22, 2020

(54) SYSTEM AND METHOD FOR SEARCHABLE BACKUP DATA

(71) Applicant: EMC IP Holding Company LLC, Hopkinton, MA (US)

(72) Inventors: Gajendran Raghunathan, Bangalore (IN); Nitin Anand, Bangalore (IN); Vipin Kumar Kaushal, Bharthana Etawah (IN); Anand Reddy, Bangalore (IN); Krishnendu Bagchi, Bangalore (IN); Sudha Vamanraj Hebsur, Bangalore (IN); Niketan Narayan Kalaskar, Bangalore (IN); Pallavi Prakash, Bangalore (IN); Matthew Dickey Buchman, Seattle, WA (US); Jaishree Balasubramanian, Bangalore (IN); Shelesh Chopra, Bangalore (IN)

(21) Appl. No.: 16/388,859

(22) Filed: Apr. 18, 2019

(51) Int. Cl. G06F 11/14; G06F 16/2455; G06F 16/248; G06F 9/455; G06F 16/951

(52) U.S. Cl. CPC G06F 11/1464; G06F 16/2455; G06F 16/248; G06F 9/45558; G06F 2009/4557; G06F 2201/815; G06F 2009/45595; G06F 2009/45583; G06F 16/951

(57) ABSTRACT

A backup storage includes a persistent storage for storing backups of entities and a backup data map. The backup storage also includes a backup manager that obtains a search request for data; obtains at least two data maps associated with at least two of the entities; generates the backup data map using the at least two data maps; searches the backups for the data using the backup data map to identify a copy of the data; and provides the copy of the data in response to the search request.

### BACKGROUND

Computing devices may generate data during their operation. For example, applications hosted by the computing devices may generate data used by the applications to perform their functions. Such data may be stored in persistent storage of the computing devices. Failure of the persistent storage may result in data loss.

For example, when a database application modifies a database stored in persistent storage, data that is relevant to a user that initiated the modification of the database may become stored in the database. If only a single copy of the database is stored in the persistent storage, failure of the persistent storage may render the data relevant to the user to be irretrievable.

### SUMMARY

In one aspect, a backup storage in accordance with embodiments of the invention includes a persistent storage for storing backups of entities and a backup data map. The backup storage also includes a backup manager that obtains a search request for data; obtains at least two data maps associated with at least two of the entities; generates the backup data map using the at least two data maps; searches the backups for the data using the backup data map to identify a copy of the data; and provides the copy of the data in response to the search request.

In one aspect, a method for searching backups of entities using a backup data map in accordance with one or more embodiments of the invention includes obtaining a search request for data; obtaining at least two data maps associated with at least two of the entities; generating the backup data map using the at least two data maps; searching the backups for the data using the backup data map to identify a copy of the data; and providing the copy of the data in response to the search request.

In one aspect, a non-transitory computer readable medium in accordance with one or more embodiments of the invention includes computer readable program code, which when executed by a computer processor enables the computer processor to perform a method for searching backups of entities using a backup data map. The method includes obtaining a search request for data; obtaining at least two data maps associated with at least two of the entities; generating the backup data map using the at least two data maps; searching the backups for the data using the backup data map to identify a copy of the data; and providing the copy of the data in response to the search request.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2.1 shows a diagram of an example production host in accordance with one or more embodiments of the invention.

FIG. 2.2 shows a diagram of an example virtual machine in accordance with one or more embodiments of the invention.

FIG. 3 shows a diagram of an example backup storage in accordance with one or more embodiments of the invention.

FIG. 4.1 shows a flowchart of a method of performing a search of non-natively searchable data in accordance with one or more embodiments of the invention.

FIG. 4.2 shows a flowchart of a method of obtaining a data map in accordance with one or more embodiments of the invention.

FIG. 5 shows a flowchart of a method of responding to a backup generation request in accordance with one or more embodiments of the invention.

FIGS. 6.1-6.6 shows a non-limiting example of a system in accordance with embodiments of the invention.

FIG. 7 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to systems, devices, and methods for providing data protection services. Embodiments of the invention may provide a method for searching backup data that is in a format that is non-natively searchable.

In one or more embodiments of the invention, the backup data may be stored in a format that is non-natively searchable. A non-natively searchable format may not include metadata regarding the structure of the data. The non-natively searchable format for data may decrease the storage footprint of the data by eliminating and/or greatly reducing such metadata from other formats that are natively searchable, e.g., a file system.

In one or more embodiments of the invention, the search functionality for the backup data is provided using integrated backup managers that continuously monitor the states of entities which data protection services are to be provided. The monitoring may be used to generate data maps of the entities. When backups of the entities are generated for data protection purposes, corresponding data maps may be generated. The data maps may be aggregated to generate an index for searching all of the backups of the entities. By doing so, the backups of the entities may be stored in a non-natively searchable format for data storage purposes while still enabling the backups of the entities to be searched using the index.

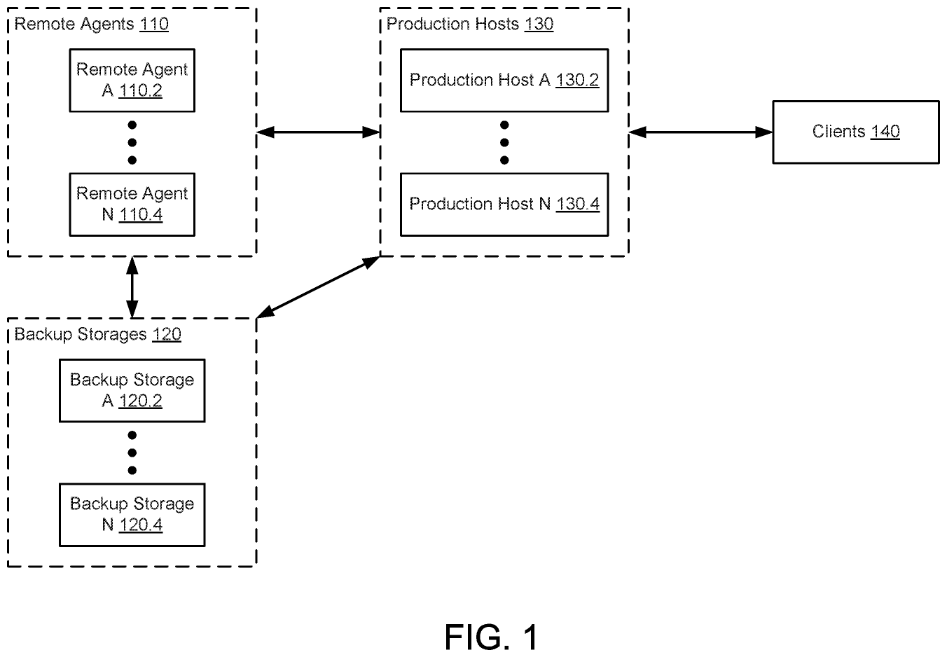

FIG. 1 shows an example system in accordance with one or more embodiments of the invention. The system may include clients (140) that obtain services from virtual machines and/or applications hosted by production hosts (130). For example, the production hosts (130) may host virtual machines that host applications. The clients (140) may utilize application services of the applications. The applications may be, for example, database applications, electronic communication applications, file storage applications, and/or any other type of application that may provide services to the clients (140). By utilizing such services, data that is relevant to the clients (140) may be stored in the production hosts (130).

To improve the likelihood that data stored in the production hosts (130) is available for future use for restoration purposes, backups of the production hosts (130) may be generated and stored in the backup storages (120). A backup of one of the production hosts (130) may include data that may be used to restore all, or a portion, of the production host, or all, or a portion, of an entity hosted by the production host, to a previous state. Thus, if data hosted by one of the production hosts (130) is lost, access to the data may be restored by restoring all, or a portion, of the production host using information stored in the backup storages (120).

The system may also include remote agents (110) that provide data protection services to the production hosts (130). The data protection services may include orchestrating generation and storage of backups in the backup storages and/or orchestrating restorations using the data stored in the backup storages (120). Performing a restoration of a production host (e.g., 130.2, 130.4) may return the production host, or an entity hosted by the production host, to a previous state.

To maximize the quantity of backup data storable in the backup storages, the backups may be stored in a format that is not indexed and/or deduplicated against other data stored in the backup storages. However, it may still be desirable to be able to search through data of the backups stored in the backup storages.

To provide search functionality, the remote agents (110) and/or the backup storages (120) may maintain an index of the data of the backups stored in the backup storages (120). By doing so, data in the backup of the backup storages (120) may still be searched while minimizing the storage footprint of the data stored in the backup storages (120).

The components of the system illustrated in FIG. 1 may be operably connected to each other and/or operably connected to other entities (not shown) via any combination of wired and/or wireless networks. Each component of the system illustrated in FIG. 1 is discussed below.

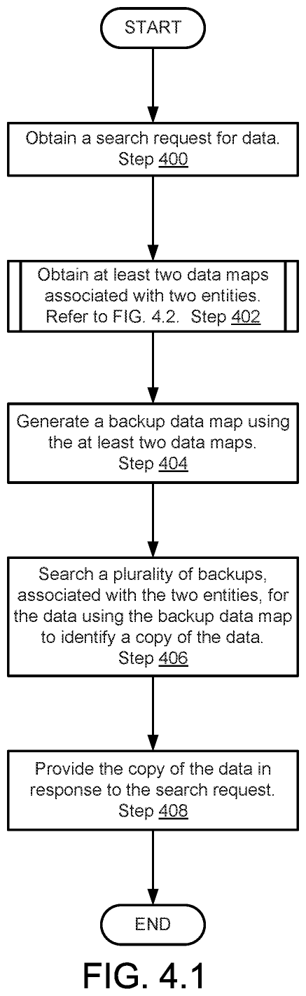

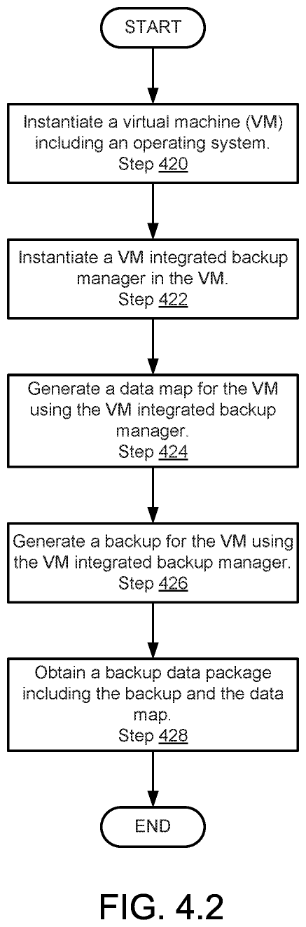

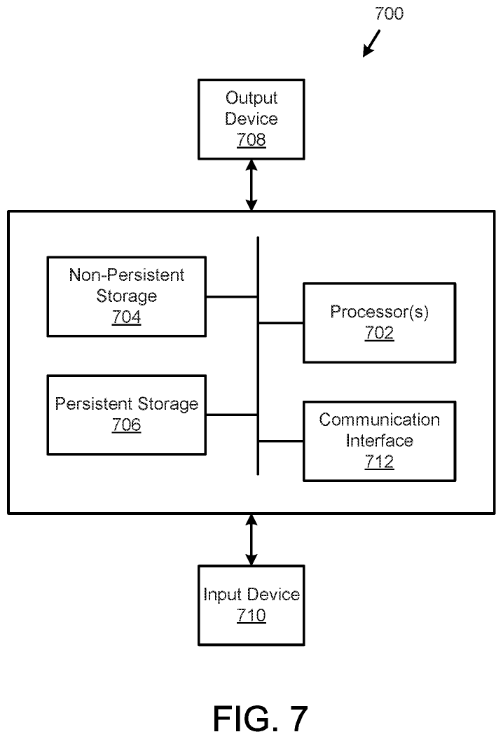

The clients (140) may be computing devices. The computing devices may be, for example, mobile phones, tablet computers, laptop computers, desktop computers, servers, or cloud resources. The computing devices may include one or more processors, memory (e.g., random access memory), and persistent storage (e.g., disk drives, solid state drives, etc.). The persistent storage may store computer instructions, e.g., computer code, that when executed by the processor(s) of the computing device cause the computing device to perform the functions described in this application and/or all, or portion, of the methods illustrated in FIGS. 4.1-5. The clients (140) may be other types of computing devices without departing from the invention. For additional details regarding computing devices, refer to FIG. 7.

The clients (140) may be logical devices without departing from the invention. For example, the clients (140) may be virtual machines that utilize computing resources of any number of physical computing devices to provide the functionality of the clients (140). The clients (140) may be other types of logical devices without departing from the invention.

In one or more embodiments of the invention, the clients (140) utilize application services provided by the production hosts (130). For example, the clients (140) may utilize database services, electronic communication services, file storage services, or any other type of computer implemented service provided by applications hosted by the production hosts (130). By utilizing the aforementioned services, data that is relevant to the clients (140) may be stored as part of application data of the applications hosted by the production hosts (130).

For example, consider a scenario in which a client utilizes file storage services provided by an application of the production hosts (130) by uploading an image to an application hosted by the production hosts (130). In response to receiving the uploaded image, the application may store a copy of the image locally in the production hosts (130). At a future point in time, the client that uploaded the image, or another entity, may desire to retrieve a copy of the image from the production hosts (130) and thereby provide data, i.e., the copy of the image sort of the production hosts (130), stored in the production hosts (130) that is relevant to the clients (140). One or more embodiments of the invention may improve the likelihood that data that is relevant to the clients (140) and stored in the production hosts (130) is retrievable from the production hosts (130) at future points in time. Embodiments of the invention may provide such functionality by generating and storing backups of the production hosts, or portions of the production hosts, in the backup storages (120).

In one or more embodiments of the invention, the production hosts (130) are computing devices. The computing devices may be, for example, mobile phones, tablet computers, laptop computers, desktop computers, servers, distributed computing systems, or a cloud resource. The computing devices may include one or more processors, memory (e.g., random access memory), and persistent storage (e.g., disk drives, solid state drives, etc.). The persistent storage may store computer instructions, e.g., computer code, that when executed by the processor(s) of the computing device cause the computing device to perform the functions described in this application and/or all, or portion, of the methods illustrated in FIGS. 4.1-5. The production hosts (130) may be other types of computing devices without departing from the invention. For additional details regarding computing devices, refer to FIG. 7.

In one or more embodiments of the invention, the production hosts (130) are distributed computing devices. As used herein, a distributed computing device refers to functionality provided by a logical device that utilizes the computing resources of one or more separate and/or distinct physical computing devices. For example, in one or more embodiments of the invention, the production hosts (130) may be distributed devices that include components distributed across any number of separate and/or distinct computing devices. In such a scenario, the functionality of the production hosts (130) may be performed by multiple, different computing devices without departing from the invention.

A system in accordance with one or more embodiments of the invention may include any number of production hosts (e.g., 130.2, 130.4) without departing from the invention. For example, a system may include a single production host (e.g., 130.2) or multiple production hosts (e.g., 130.2, 130.4).

In one or more embodiments of the invention, the production hosts (130) provide services to the clients (140). The services may be any type of computer implemented service such as, for example, database services, electronic communication services, data storage services, and/or instant messaging services. When providing such services to the clients (140), data that is relevant to the clients (140) may be stored in persistent storage of the production hosts (130).

In one or more embodiments of the invention, the production hosts (130) perform backup services such as, for example, generating and storing backups in backup storages (120). By storing backups in the backup storages (120), copies of data stored in persistent storage of the production hosts (130) may be redundantly stored in the backup storages (120). By redundantly storing copies of data in both the production hosts (130) and the backup storages (120), it may be more likely that the stored data will be able to be retrieved at a future point in time. For example, if a production host (e.g., 130.2) suffers a catastrophic failure or other type of data loss/corruption event, the data on the production host's persistent storage may be lost. However, because copy of the data may be stored in the backup storages (120), it may be possible to retrieve the data for use after the catastrophic failure. Thus, embodiments of the invention may improve the reliability of data storage in a distributed system.

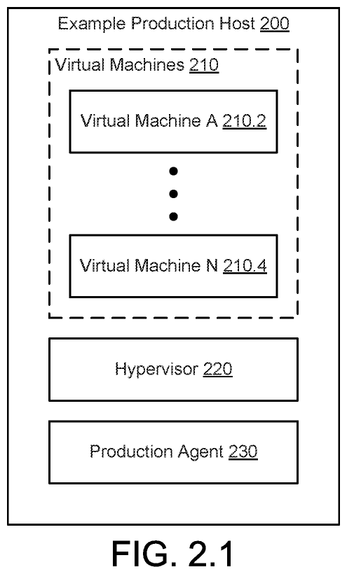

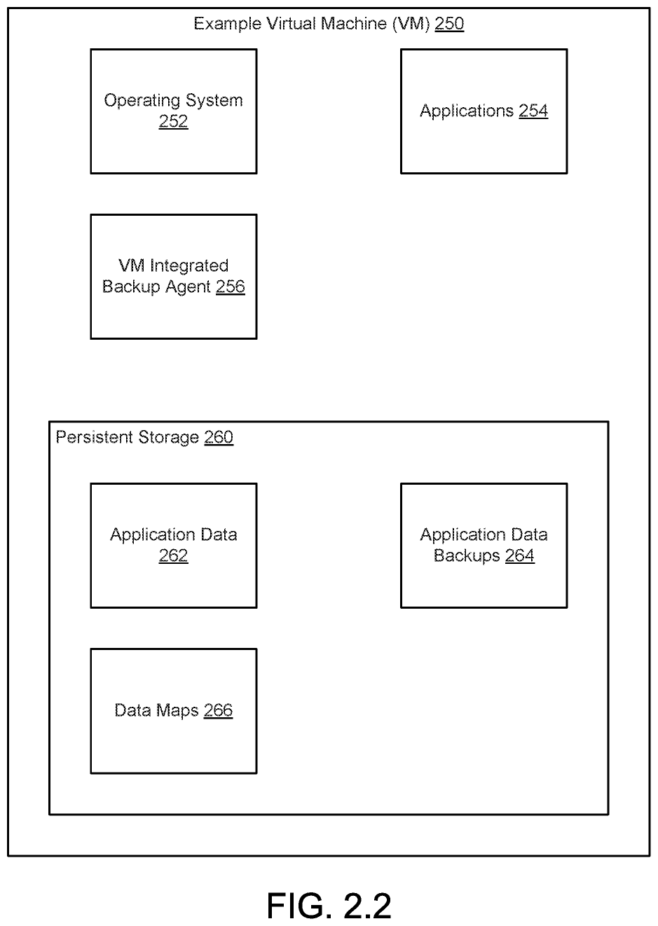

Backup services may also include generating data maps of data included in the backups stored in the backup storages. The data maps may be utilized by the remote agents (110) and/or the backup storages (120) to generate a backup data map that enables data included in the backups stored in the backup storages (120) to be searched. For additional details regarding the production hosts (130), refer to FIG. 2.1.

In one or more embodiments of the invention, the backup storages (120) are computing devices. The computing devices may be, for example, mobile phones, tablet computers, laptop computers, desktop computers, servers, distributed computing systems, or a cloud resource. The computing devices may include one or more processors, memory (e.g., random access memory), and persistent storage (e.g., disk drives, solid state drives, etc.). The persistent storage may store computer instructions, e.g., computer code, that when executed by the processor(s) of the computing device that cause the computing device to provide the functionality of the backup storages (120) described through this application and all, or a portion, of the methods illustrated in FIGS. 4.1-5. The backup storages (120) may be other types of computing devices without departing from the invention. For additional details regarding computing devices, refer to FIG. 7.

In one or more embodiments of the invention, the backup storages (120) are distributed computing devices. As used herein, a distributed computing device refers to functionality provided by a logical device that utilizes the computing resources of one or more separate and/or distinct computing devices. For example, in one or more embodiments of the invention, the backup storages (120) are distributed devices that include components distributed across any number of separate and/or distinct computing devices. In such a scenario, the functionality of the backup storages (120) may be performed by multiple, different computing devices without departing from the invention.

In one or more embodiments of the invention, the backup storages (120) provide data storage services to the production hosts (130). The data storage services may include storing of data provided by the production hosts (130) and providing of previously stored data to the production hosts (130). Such provided data may be used for restoration (and/or other) purposes. The system may include any number of backup storages (e.g., 120.2, 120.4) without departing from the invention. For example, the system in accordance with embodiments of the invention may only include a single backup storage (e.g., 120.2) or may include multiple backup storages (e.g., 120.2, 120.4).

In one or more embodiments of the invention, the data stored by the backup storages (120) includes backups of virtual machines and/or applications hosted by the production hosts (130). For example, the production hosts (130) may host a virtual machine that hosts a database application. To generate backups of the database, a backup of the virtual machine hosting the database may be generated and the backup may be sent to the backup storages (120) for storage. At a future point in time, it may become desirable to restore the state of the database managed by the database application to a previous state. To do so, the previously stored backup of the virtual machine stored in the backup storages (120) may be retrieved. The retrieved backup may be used to restore virtual machine hosting the database to a state associated with the backup, i.e., the desired previous state.

Additionally, application level backups may be stored in backup storage (120), rather than in virtual machine level backups. Thus, backups of the production hosts (130) may be generated at any level of granularity with respect to the data stored in the production hosts (130), e.g., on a virtual machine level, application level, etc. Combinations of virtual machine level backups, application level backups, and/or other types of backups may be utilized to selectively restore the functionality of virtual machines and/or applications hosted by virtual machines.

For example, to restore an application to a desired state a virtual machine backup may be used to instantiate a copy of a virtual machine that hosts an application in an undesirable state. After instantiating the virtual machine, an application level backup may be used to restore the state of the application hosted by the virtual machine to the desired state. Thus, the state of the application may be in the desired state while the state of the virtual machine may be in another state (but does not impact the functionality of the now-desirable state of the application).

In addition to providing data storage and restoration services, the backup storages (120) may also provide search services. The search services may enable the location of data within the backups to be determined. Such information may be used to obtain the search for data, restore an entity that has access to the data, or other purposes.

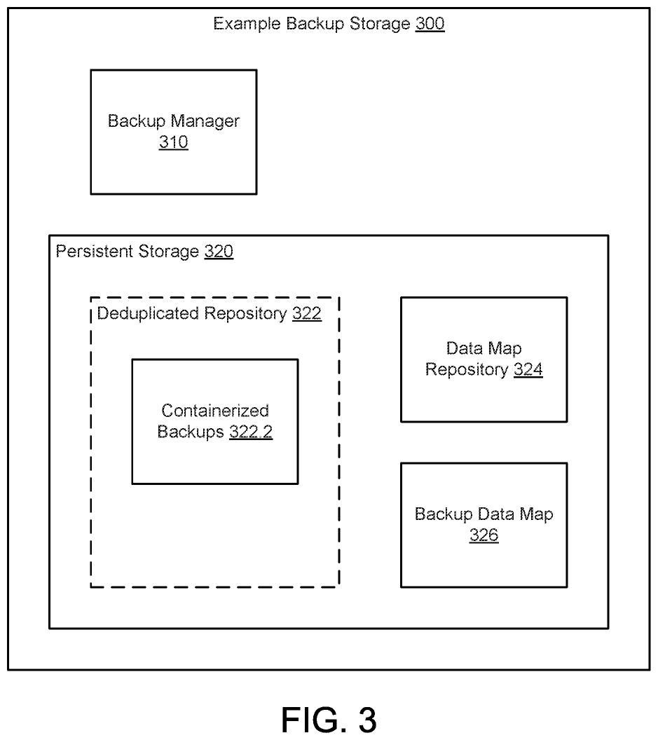

While described above as storing backups of virtual machines, applications, and/or production hosts (130), the backup storages (120) may store other types of data from the production hosts (130), or other entities, without departing from the invention. For example, the backup storages (120) may store archives or other data structures from the clients (140) and/or other entities. For additional details regarding the backup storages (120), refer to FIG. 3

In one or more embodiments of the invention, the remote agents (110) are computing devices. The computing devices may be, for example, mobile phones, tablet computers, laptop computers, desktop computers, servers, distributed computing systems, or a cloud resource. The computing devices may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to provide the functionality of the remote agents (110) described through this application and all, or a portion, of the methods illustrated in FIGS. 4.1-5. The remote agents (110) may be other types of computing devices without departing from the invention. For additional details regarding computing devices, refer to FIG. 7.

In one or more embodiments of the invention, the remote agents (110) are distributed computing devices. As used herein, a distributed computing device refers to functionality provided by a logical device that utilizes the computing resources of one or more separate and/or distinct computing devices. For example, in one or more embodiments of the invention, the remote agents (110) may be distributed devices that include components distributed across any number of separate and/or distinct computing devices. In such a scenario, the functionality of the remote agents (110) may be performed by multiple, different computing devices without departing from the invention.

In one or more embodiments of the invention, the backup storages (120) provide the functionality of the remote agents. For example, the backup storages (120) may host applications that provide all, or a portion, of the functionality of the remote agents (110).

In one or more embodiments of the invention, the remote agents (110) orchestrate provisioning of backup services to the production hosts (130). For example, the remote agents (110) may initiate the process of backup generation for the production hosts (130) and storage of the generated backups in the backup storages (120). Additionally, the remote agents (110) may orchestrate restoration of the production hosts (130) using backups stored in the backup storages (120). For example, remote agents (110) may initiate copying of backups from the backup storages to the production hosts and initiate restorations using the copied backups. The system of FIG. 1 may include any number of remote agents (e.g., 110.2, 110.4).

While the system of FIG. 1 has been described and illustrated as including a limited number of components for the sake of brevity, a system in accordance with embodiments of the invention may include additional, fewer, and/or different components than those illustrated in FIG. 1 without departing from the invention.

As discussed above, production hosts may host virtual machines, applications, or other entities that provide services to the clients. FIG. 2.1 shows a diagram of an example production host (200) in accordance with one or more embodiments of the invention. The example production host (200) may be similar to any of the production hosts (130, FIG. 1). As discussed above, the example production hosts (200) may provide: (i) application services to the clients, (ii) backup services to the entities that provide the application services to the clients, and (iii) restoration services.

To provide the aforementioned functionality of the example production host (200), the example production host (200) may include virtual machines (210), a hypervisor (220), and a production agent (230). Each component of the example production host (200) is discussed below.

The virtual machines (210) may be applications. For example, the virtual machines (210) may be applications executing using physical computing resources of the example production host (200). In other words, each of the virtual machines (210) may be implemented as computer instructions stored in persistent storage that (when executed by a processor of the example production host (200)) give rise to the functionality of the respective virtual machine. The example production host (200) may host any number of virtual machines (e.g., 210.2, 210.4) without departing from the invention.

Each of the virtual machines (210) may host any number of applications. The applications may provide application services to clients or other entities. For example, the applications may be database applications, electronic communication applications, file sharing applications, and/or other types of applications. Each of the virtual machines (210) may host any number of applications without departing from the invention.

Each of the applications may perform similar or different functions. For example, a first application may be a database application and a second application may be an electronic communications application. In another example, a first application may be a first instance of a database application and a second application may be a second instance of the database application.

In one or more embodiments of the invention, all, or a portion, of the applications provide application services to clients. The provided services may correspond to the type of application of each of the applications. When providing application services to the clients, data that is relevant to the clients may be received by and/or generated by the applications. The applications may store such relevant data as part of the application data associated with respective applications in persistent storage.

In some embodiments of the invention, portions, or all, of the application data may be stored remotely from the example production host (200). For example, the application data may be stored in a second production host, or another entity, that does not host the applications. The application data may be stored in other locations without departing from the invention.

While the applications have been described above as being hosted by the virtual machines (210), the applications may not be hosted by virtual machines without departing from the invention. For example, the applications may be executing natively on the example production host (200) rather than in a virtualized entity.

Each of the virtual machines (210.2, 214.4) may also generate data maps. The data maps may specify the data included in virtual machine and/or an application hosted by the virtual machine. The data maps may be continuously updated and provided to other entities as part of the process of generating a backup of a virtual machine or an entity hosted by the virtual machine. By doing so, other entities may be able to deduce the contents of backups and, consequently, may be used to provide search services for the contents of the backups stored in the backup storages. For additional details regarding the virtual machines (210), refer to FIG. 2.2.

The hypervisor (220) may manage execution of the virtual machines (210). The hypervisor (220) may instantiate and/or terminate any of the virtual machines (210). The hypervisor (220) may also allocate computing resources of the example production host (200) to each of the virtual machines (e.g., 210.2, 210.4).

For example, the hypervisor (220) may allocate a portion of the persistent storage of the example production host (200). Any quantity of storage resources of the persistent storage may be allocated in any manner among the virtual machines (e.g., 210.2, 210.4).

While discussed with respect to storage resources, the hypervisor (220) may allocate other types of computing resources to the virtual machines (210), and/or other entities hosted by the example production host (200), without departing from the invention. For example, the hypervisor (220) may allocate processor cycles, memory capacity, memory bandwidth, and/or network communication bandwidth among the virtual machines (210) and/or other entities hosted by the example production host (200).

In one or more embodiments of the invention, the hypervisor (220) is a hardware device including circuitry. The hypervisor (220) may be, for example, a digital signal processor, a field programmable gate array, or an application specific integrated circuit. The hypervisor (220) may be other types of hardware devices without departing from the invention.

In one or more embodiments of the invention, the hypervisor (220) is implemented as computing code stored on a persistent storage that when executed by a processor performs the functionality of the hypervisor (220). The processor may be a hardware processor including circuitry such as, for example, a central processing unit or a microcontroller. The processor may be other types of hardware devices for processing digital information without departing from the invention.

The production agent (230) may locally manage provisioning of backup services to the virtual machines (210) and/or entities hosted by the virtual machines (210). For example, the production agent (230) may orchestrate the generation of backups and storage of the generated backups in backup storage. To orchestrate the generation of backups, the production agent (230) may generate virtual machine level backups and/or application level backups. A virtual machine level backup may be a backup that represents the state (or difference from one state to another state) of a virtual machine at a point in time. An application level backup may be a backup that represents the state (or difference from one state to another state) of an application hosted by a virtual machine at a point in time. Different types and/or combinations of backups may be used to restore virtual machines and/or applications hosted by virtual machines (or natively executing on a production host) to states associated with different points in time.

In one or more embodiments of the invention, the production agent (230) manages the provisioning of backup services for the virtual machines (210) based on instructions received from one or more remote agents. These instructions may cause the production agent (230) to take action to provide the backup services. In other words, the production agents (230) may orchestrate data protection services including generation of backups and performance of restorations across the system.

In one or more embodiments of the invention, the instructions from remote agents specify that backups are to be generated dynamically. For example, instructions may specify that backups are to be generated in response to predetermined events rather than at a particular point in time. The predetermined event may be the storage of a predetermined quantity of data by an entity hosted by the example production host (200) after a predetermined point in time.

For example, consider a scenario in which a remote agent sends an instruction to a production agent that specifies that backups for a virtual machine hosted by the example production host (200) are to be generated whenever the virtual machine stores 200 Gigabytes (GB) of data. In response to this instruction, the production agent (230) may monitor, or otherwise set up watches for, the data storage of the virtual machine. When the data storage of the virtual machine reaches 200 GB, the production agent may initiate a backup generation for the virtual machine.

In one or more embodiments of the invention, the production agent (230) includes functionality to report backup generation activity to remote agents. For example, the production agent (230) may monitor backups that are generated and send notifications of the generated backups to the remote agents. By doing so, remote agents may be notified of the backup generations for the entities hosted by the example production host (200).

The production agent (230) may also provide restoration services. Restoration services may enable entities that are now inaccessible due to, for example, failure of a host entity such as a production host to be instantiated in other locations and being in predetermined states. To provide restoration services, the production agent (230) may obtain any number of backups from backup storage and restore the entity using the backups. For example, a production agent (230) may obtain a virtual machine level backup and an application level backup. The virtual machine level backup may be an image of a virtual machine and may be utilized to instantiate a copy of a virtual machine. After instantiating a copy of the virtual machine, the application level backup may be utilized to restore a state of an application hosted by the instantiated virtual machine. By doing so, a virtual machine hosting an application in a predetermined state may be obtained. Once in the predetermined state, the application may provide desired application services and/or enable access to application data of the application. The entities may be restored to different, desirable states using different combinations of previously generated backups. Any combination of backups may be used to restore entities without departing from the invention.

To provide the above noted functionality of the production agent (230), the production agent (230) may perform all, or a portion, of the methods illustrated in FIGS. 4.1-5.

In one or more embodiments of the invention, the production agent (230) is a hardware device including circuitry. The production agent (230) may be, for example, a digital signal processor, a field programmable gate array, or an application specific integrated circuit. The production agent (230) may be other types of hardware devices without departing from the invention.

In one or more embodiments of the invention, the production agent (230) is implemented as computing code stored on a persistent storage that when executed by a processor performs the functionality of the production agent (230). The processor may be a hardware processor including circuitry such as, for example, a central processing unit or a microcontroller. The processor may be other types of hardware devices for processing digital information without departing from the invention.

While the example production host (200) of FIG. 2.1 has been described and illustrated as including a limited number of components for the sake of brevity, a production host in accordance with embodiments of the invention may include additional, fewer, and/or different components than those illustrated in FIG. 2.1 without departing from the invention.

As discussed above, virtual machines hosted by the production hosts may provide services to clients. FIG. 2.2 shows a diagram of an example virtual machine (250) in accordance with one or more embodiments of the invention.

The example virtual machine (250) may host an operating system (252) that manages operations of the example virtual machine (250). For example, the operating system (252) may manage access to resources such as persistent storage (260). Additionally, the operating system (252) may provide notification services to other entities hosted by the example virtual machine (250) regarding operation of the example virtual machine (250) and/or other entities hosted by the example virtual machine (250). For example, the operating system (252) may enable entities to register with the operating system (252) to receive updates regarding changes to data stored in the persistent storage (260). The operating system (252) may provide additional and/or other types of services to entities hosted by the example virtual machine (250) without departing from the invention.

The example virtual machine (250) may host any number and type of applications (254). The applications (254) may provide services to clients and/or other entities. The applications (254) may generate application data (262) stored in persistent storage (260).

The example virtual machine (250) may also host a virtual machine integrated backup agent (256). The virtual machine integrated backup agent (256) may provide data protection services including (i) generation of backups of the applications, (ii) restorations of applications using previously generated backups, and (iii) generation of data maps (266). The data maps (266) may be data structures that reflect the layout of application data (262) and/or other data stored in the persistent storage (260). In other words, the data maps (266) may be metadata that describes organization of data of the example virtual machine (250).

The data maps (266) may be at any level of granularity without departing from the invention. For example, a data map (266) may describe the organization of files managed by the operating system (252). In such a scenario, the data may include (i) the name of each file, (ii) a description of each file, and (iii) organizational information such as the offsets to the start of each file, the length of each file, and/or other information that may be used to access different portions of all of the data of the example virtual machine (250).

In another example, a data map (266) may describe the organizational layout of an aggregate data structure such as, for example, a database. In such a scenario, the data map may include (i) the identifier of each portion of the aggregate data structure, (ii) a description of each portion of the aggregate data structure, and organizational information such as the offsets to the start of each portion of the aggregate data structure, the length of each portion of the aggregate data structure, and/or other information that may be used to access different portions of the aggregate data structure. Such aggregate data structures may be generated by the applications (254).

To generate data maps at a virtual machine level, the virtual machine integrated backup agent (256) may (i) crawl, upon instantiation, data stored in the persistent storage (260) to generate an initial data map, (ii) register with the operating system (252) to monitor changes to data stored in the persistent storage (260), and (iii) continuously update the initial data map based on the monitored changes to obtain a data map that reflects the data stored in the persistent storage (260) of the example virtual machine (250).

To generate data maps at an application level, the virtual machine integrated backup agent (256) may (i) export an organization table from an application that reflects the structure of application data (262) corresponding to the application, (ii) monitor changes to the application data (262) using the application, and (iii) continuously update the exported table based on the monitored changes to obtain a data map that reflects the data stored in the persistent storage (260) of the example virtual machine (250). Alternatively, the virtual machine integrated backup agent (256) may export the organizational table from the application at the time the data map for the application data is required.

The virtual machine integrated backup agent (256) may also include functionality to generate application data backups (264). The application data backups (264) may be backups of the application data (262). To generate application data backups (264), the virtual machine integrated backup agent (256) may make a metadata free copy of the application data (262), may invoke functionality of the applications (254) to export an archive of the application data associated with the application as the application backup data, or may generate a backup of the application data via other methods. Once generated, the virtual machine integrated backup agent (256) and/or other entities may orchestrate storage of the application data backups (264) in backup storage. By doing so, a copy of the application data may be stored in another location.

In one or more embodiments of the invention, one or more of the data maps (266) are sent along with backups to the backup storages. As will be discussed in greater detail with respect to FIG. 3, the data maps (266) may be used to generate an index of all of the backup data in the backup storages.

In one or more embodiments of the invention, the persistent storage (260) is a logical storage (e.g., virtualized storage) that utilizes any quantity of hardware storage resources of a production host (and/or other entity) that hosts the example virtual machine (250). For example, the persistent storage (260) may utilize portions of any combination of hard disk drives, solid state disk drives, tape drives, and/or any other physical storage medium of a production host and/or other entity for providing storage resources. Such storage resources may be used to store the application data (262), application data backups (264), data maps (266), and/or other data structures.

As discussed above, backups and/or data maps may be sent to backup storages for data integrity purposes. FIG. 3 shows a diagram of an example backup storage (300) in accordance with one or more embodiments of the invention. The example backup storage (300) may be similar to any of the backup storages (120, FIG. 1). As discussed above, the example backup storage (300) may store data such as backups that may be used for restoration purposes. Additionally, the example backup storage (300) may provide search functionality for the data included in the backups stored in the example backup storage (300).

To provide the aforementioned functionality of the example backup storage (300), the example backup storage (300) may include a backup manager (310) and a persistent storage (320). Each component of the example backup storage (300) is discussed below.

In one or more embodiments of the invention, the backup manager (310) provides data storage services. For example, the backup manager (310) may orchestrate the storage of backups from production hosts in persistent storage (320) resulting in the storage of backups.

When providing data storage services, the backup manager (310) may deduplicate the backups against already-stored backups. To deduplicate the backups for storage, the backup manager (310) may divide the backups into any number of portions, comparing those portions to existing portions the data stored in a deduplicated repository (322), and only store the portions of the backups that are not duplicative of existing portions already stored in the deduplicated repository (322). Additionally, the example backup storage (300) may store instructions regarding how to combine different portions of data stored in the deduplicated repository (322) to obtain backups now stored in a deduplicated manner in the deduplicated repository. By doing so, more backups may be stored in the example backup storage (300).

Additionally, the backup manager (310) may store the backups in a containerized format. For example, containerized backups (322.2), after deduplication, may be stored in the deduplicated repository (322). The containerized format may not include metadata or other information regarding the contents of each container of the containerized format. Rather, a containerized format may store volume data in discrete containers without including information regarding the structure of the data inside of each container. By doing so, the containerized format may have a smaller storage footprint when compared to other formats (e.g., file systems). Consequently, more backups may be stored as containerized backups (322.2) when compared to storing the backups in other formats that include metadata regarding the data. However, the information included in the containerized backups may not be natively searchable.

To provide search functionality, the backup manager (310) may generate the backup data map (326) using data maps obtained from the production hosts. The data maps, upon receipt, may be stored in the data map repository (324). The backup manager (310) may use each of the data maps to construct the backup data map (326). As backups are deduplicated and stored as containerized backups (322.2), the backup manager (310) may update the backup data map (326) using the data maps stored in the data map repository (324). By doing so, the backup data map (326) may be used to provide search functionality for all of the backups stored in the example backup storage (300).

Additionally, the backup manager (310) may add additional metadata to the backup data map (326). For example, the backup manager (310) may add metadata regarding each indexed portion of data included in the backup data map (326). The metadata may specify the applications associated with each indexed portion of the data. By doing so, search functionality based on applications, rather than just data, may be provided the backup data map (326). Additional and/or different types of metadata, other than associations with applications, may be added to the backup data map (326) without departing from the invention. By doing so, multidimensional search functionality may be provided using the backup data map (326).

In one or more embodiments of the invention, the backup manager (310) provides restoration services. Restoration services may include providing information regarding the backups stored in the deduplicated repository (322), e.g., whether particular data exists, whether different applications are associated with data associated with backups of entities, etc., to a user and providing copies of the backups stored in the deduplicated repository (322) to production hosts for restoration purposes. For example, the user may first need to identify the location of valuable data to make an informed selection of an entity to be restored so that the valuable data is accessible upon restoration of the entity. When providing information regarding the backups to the user and/or the backups stored in the deduplicated repository (322) to a production host, the backup manager (310) may perform all, or a portion of the method of FIGS. 4.1-5.

In one or more embodiments of the invention, the backup manager (310) is a hardware device including circuitry. The backup manager (310) may be, for example, a digital signal processor, a field programmable gate array, or an application specific integrated circuit. The backup manager (310) may be other types of hardware devices without departing from the invention.

In one or more embodiments of the invention, the backup manager (310) is implemented as computing code stored on a persistent storage that when executed by a processor performs the functionality of the backup manager (310). The processor may be a hardware processor including circuitry such as, for example, a central processing unit or a microcontroller. The processor may be other types of hardware devices for processing digital information without departing from the invention.

In one or more embodiments of the invention, the persistent storage (320) is a data storage device. For example, the persistent storage (320) may be any combination of hard disk drives, solid state disk drives, tape drives, and/or any other physical storage medium for the storage of data. The persistent storage (320) may store the deduplicated repository (322), the data map repository (324), and the backup data map (326). Each of these data structures is discussed below.

The deduplicated repository (322) may be a data structure that includes deduplicated data. As discussed above, deduplicating data may reduce the footprint of the data. However, duplication may be a computationally expensive process and obtaining data from a deduplicated repository (322) may also be computationally expensive. For example, the process of determining whether a portion of data is duplicative of data in the deduplicated repository (322) may consume significant processing, memory, and storage resources. Similarly, the process of obtaining data by stitching together any number of portions of data stored in the deduplicated repository (322) may be computationally expensive. Accordingly, it may not be computationally reasonable to crawl data stored in a deduplicated repository (322) for search purposes.

The deduplicated repository (322) may also store the deduplicated in a containerized format, e.g., containerized backups (322.2). As discussed above, the containerized format may be a data storage format that reduces overhead of storing data by minimizing metadata. Data in a containerized format may be stored in logical containers which improve the amount of data that may be stored when compared to other methods of storing data such as via a file system that includes metadata which provides for native searching of the stored data.

The data map repository (324) may be a data structure that includes data maps from production hosts. As discussed above, when a backup is sent for storage and the example backup storage (300) a corresponding data map may also be sent. The data maps may be stored in the data map repository (324). As data maps and the data map repository (324) are utilized to generate backup data map, the data maps may be deleted or retained.

The backup data map (326) may be a data structure that includes information regarding the backups that have been stored in the example backup storage (300). For example, the backup data map (326) may include information that allows for the backups that have been stored in the example backup storage (300) to be searched.

In one or more embodiments of the invention, the backup data map (326) includes an index of the portions of the data of the backups that have been stored in the example backup storage (300). For example, the backup data map (326) may include a listing of all the files and/or portions of the files that have been stored, as part of the backups, in the example backup storage (300).

In one or more embodiments of the invention, the backup data map (326) includes metadata regarding all of the files and/or portions of the files that have been stored, as part of the backups, in the example backup storage (300). The metadata may specify associations between the files and/or portions of the files with different applications. The metadata may specify other information regarding the files and/or portions of the files without departing from the invention.

While the example backup storage (300) of FIG. 3 has been described and illustrated as including a limited number of components for the sake of brevity, a backup storage in accordance with embodiments of the invention may include additional, fewer, and/or different components than those illustrated in FIG. 3 without departing from the invention.

Returning to FIG. 1, the backup storages may provide data storage, backup data search, and restoration services. FIGS. 4.1-5 illustrates methods that may be performed by components of the system of FIG. 1 when providing such services.

FIG. 4.1 shows a flowchart of a method in accordance with one or more embodiments of the invention. The method depicted in FIG. 4.1 may be used to provide backup data search services in accordance with one or more embodiments of the invention. The method shown in FIG. 4.1 may be performed by, for example, a backup storage (e.g., 120, FIG. 1). Other components of the system illustrated in FIG. 1 may perform all, or a portion, of the method of FIG. 4.1 without departing from the invention.

While FIG. 4.1 is illustrated as a series of steps, any of the steps may be omitted, performed in a different order, additional steps may be included, and/or any or all of the steps may be performed in a parallel and/or partially overlapping manner without departing from the invention.

In step 400, a search request for data is obtained.

In one or more embodiments of the invention, the search request is obtained from a user. The user may desire access to the data. The search request may specify the data and/or information regarding the data. For example, the search request may specify the type of an application associated with the data rather than the data itself. The search request may be obtained from other entities without departing from the invention. For example, a production hosts or a backup manager may send the search request.

In step 402, at least two data maps associated with two entities are obtained.

In one or more embodiments of the invention, the at least two data maps are associated with two virtual machines. For example, a first data map may include information regarding the organization of data of the first virtual machine and the second data map may include information regarding the organization of data of the second virtual machine.

In one or more embodiments of the invention, each of the at least two data maps are associated with two different backups. The backups may be backups of two different virtual machines or the same virtual machine (taken at different points in time).

In one or more embodiments of the invention, the at least two data maps are associated with two applications. The applications may be hosted by two different virtual machines or the same virtual machine. For example, the at least two data maps may include information regarding the organization of the application data of each of the two applications.

In one or more embodiments of the invention, each of the at least two data maps are associated with two different backups. The two different backups may be backups of two different applications or the same application (taken at different points in time).

In one or more embodiments of the invention, the at least two backups are obtained using the method illustrated in FIG. 4.2. The at least two backups may be obtained using other methods without departing from the invention.

In step 404, a backup data map is generated using the at least two data maps.

In one or more embodiments of the invention, the backup data map is generated by updating an existing backup data map using the at least two data maps.

In one or more embodiments of the invention, the backup data map is generated by aggregating the information included in the at least two data maps. For example, an index of the information included in each of the at least two data maps may be generated.

In one or more embodiments of the invention, the backup data map is generated by adding metadata to the backup data map. The metadata may specify additional information regarding portions of the indexed information included in the backup data map. For example, information regarding associations between different portions of data and applications may be added to the backup data map. By doing so, the backup data map may enable multidimensional search of backups that have been stored to be performed using only the backup data map.

In step 406, a plurality of backups, associated with the two entities, is searched for the data using the backup data map to identify a copy of the data.

In one or more embodiments of the invention, the plurality of backups is searched by using an identifier of the data as a key for the backup data map. For example, a file name may be used as the key for the backup data map. The file name may be matched to a portion of the backup data map. The matched portion of the backup data map may specify an association between the file name and information that may be used to identify the location of the data in backup storage.

In one or more embodiments of the invention, the plurality of backups is searched by using information regarding the data as a key for the backup data map. For example, an application that may be used to access the data may be used as the key for the backup data map. An identifier of the application may be matched to a portion of the backup data map. The matched portion of the backup data map may specify an association between the application identifier and information that may be used to identify the location of the data in backup storage. Different types of information regarding the data may be used as the key for the backup data map without departing from the invention.

The copy of the data may be identified based on location information for the copy of the data included in the backup data map. For example, the backup data map may be a searchable index that associates data stored in backup storage with the location of the data within the backup storage. The location may be specified as part of a file, a portion of an aggregated data structure, or a portion of an entity that is stored in backup storage. The location may be specified at different levels of granularity without departing from the invention.

In step 408, the copy of the data is provided in response to the search request.

In one or more embodiments of the invention, the copy of the data is obtained using the data included in the backup storage. For example, the copy of the data may be obtained by extracting it from a deduplicated repository in backup storage.

The method may end following step 408.

By implementing the method of FIG. 4.1, portions of data stored as part of backups may be obtained and/or provided without crawling a repository of the backups. Doing so may reduce the computational load for providing such data when compared to methods that crawl data in deduplicated, containerized repositories of data.

FIG. 4.2 shows a flowchart of a method in accordance with one or more embodiments of the invention. The method depicted in FIG. 4.2 may be used to obtain a data map in accordance with one or more embodiments of the invention. The method shown in FIG. 4.2 may be performed by, for example, a backup storage (e.g., 120, FIG. 1). Other components of the system illustrated in FIG. 1 may perform all, or a portion, of the method of FIG. 4.2 without departing from the invention.

While FIG. 4.2 is illustrated as a series of steps, any of the steps may be omitted, performed in a different order, additional steps may be included, and/or any or all of the steps may be performed in a parallel and/or partially overlapping manner without departing from the invention.

The following method may be used to obtain a data map. All, or a portion, of the method may be repeated to obtain any number of data maps. For example, data maps for an entity may be obtained at different times to obtain multiple data maps. Similarly, data maps may be obtained from multiple entities to obtain multiple data maps. The entities may be, for example, virtual machine, applications, production hosts, or other entities of FIG. 1.

In step 420, virtual machine is instantiated. Instantiating the virtual machine may include instantiating an operating system for the virtual machine. The virtual machine may be instantiated anywhere within the system illustrated in FIG. 1.

In step 422, a virtual machine integrated backup manager is instantiated in the virtual machine. As discussed above, the virtual machine integrated backup manager may be an application that provides data protection services including orchestration of the generation of backups and/or generation of data maps.

In step 424, an initial data map for the virtual machine is generated using the virtual machine integrated backup manager.

In one or more embodiments of the invention, the initial data map is generated for the virtual machine by sending instructions to the virtual machine integrated backup manager indicating that the initial backup map is to be generated.

In one or more embodiments of the invention, instantiation of the virtual machine integrated backup manager causes the integrated virtual machine backup manager to generate the initial data map.

In one or more embodiments of the invention, the virtual machine integrated backup manager generates the initial backup map by crawling the data of the virtual machine. For example, the virtual machine integrated backup manager may identify each of the files hosted by the virtual machine that hosts the virtual machine integrated backup manager and create an index of the files. Additionally, the virtual machine integrated backup manager may include metadata within the index regarding each of the indexed files.

In one or more embodiments of the invention, the virtual machine integrated backup manager registers with the operating system, or another management entity, of the virtual machine regarding changes to files. For example, the virtual machine integrated backup manager may send a request to the operating system to receive notifications of each change to each file of the virtual machine. The virtual machine integrated backup manager may monitor the changes to the files of the virtual machine and update the initial data map to obtain the data map. The virtual machine integrated backup manager may perform such updating continuously to ensure that the state of the data map matches the state of the data of the virtual machine.

In one or more embodiments of the invention, the virtual machine integrated backup manager generates an initial backup map by exporting a table from an application prior to when the data map is desired. The table may specify the organizational structure of the application data associated with the application. The virtual machine integrated backup manager may monitor changes to the application data associated with application and update the initial backup map based on the monitoring to obtain a backup map.

In one or more embodiments of the invention, the virtual machine integrated backup manager generates the data map by exporting the table from the application at the time the backup map is desired. The table may specify the organizational structure of the application data associated with the application.

In step 426, a backup for the virtual machine is generated using the virtual machine integrated backup manager. The backup may be generated via any method without departing from the invention. The backup may be a virtual machine level backup or an application level backup.

In one or more embodiments of the invention, the backup is generated in response to a request for generation of the backup. For example, a remote agent may send a request for generation of the backup in accordance with a schedule backup generation. The request for generation of the backup may be obtained from other entities without departing from the invention. The request for generating the backup may specify the type of backup to be generated.

In step 428, a backup data package that includes the backup and the data map is obtained. For example, the virtual machine integrated backup manager may generate the backup package using the backup generated in step 426 in the data map generated in step 424. Virtual machine integrated backup manager may send the generated backup data package to backup storage.

The method may end following step 428.

By implementing the method of FIG. 4.2, data maps associated with backups may be obtained. Doing so may enable search functionality for the backups to be provided.

As discussed above, production hosts may generate backups and/or data maps.

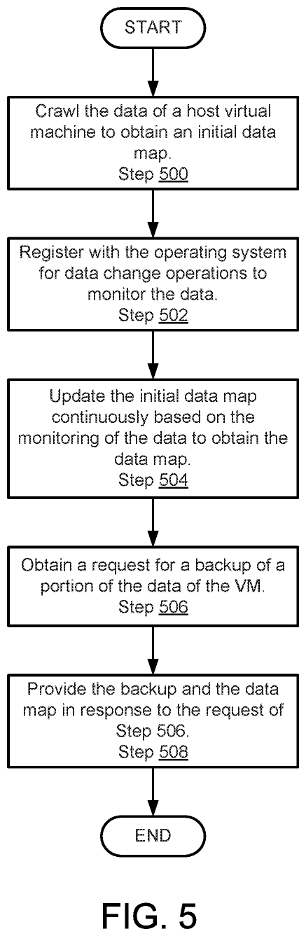

FIG. 5 shows a flowchart of a method in accordance with one or more embodiments of the invention. The method depicted in FIG. 5 may be used to respond to a backup generation request in accordance with one or more embodiments of the invention. The method shown in FIG. 5 may be performed by, for example, a production host (e.g., 130, FIG. 1). Other components of the system illustrated in FIG. 1 may perform all, or a portion, of the method of FIG. 5 without departing from the invention.

While FIG. 5 is illustrated as a series of steps, any of the steps may be omitted, performed in a different order, additional steps may be included, and/or any or all of the steps may be performed in a parallel and/or partially overlapping manner without departing from the invention.

In step 500, the data of a host virtual machine is crawled to obtain an initial data map. The data may be crawled by a virtual machine integrated backup manager. The data may be crawled to index the data of the virtual machine. The indexed data may be the data map.

In one or more embodiments of the invention, additional metadata regarding the data is added to the initial data map. For example, associations between different portions of the data and applications may be added to the data map. Other types of metadata regarding different portions of the data of the initial data map may be added to the initial data map without departing from the invention.

In step 502, the virtual machine integrated backup manager registers with the operating system for data change operations to monitor the data of the virtual machine hosting the virtual machine integrated backup manager. For example, virtual machine integrated backup manager may send a request to the operating system for any changes that are made to data of the virtual machine. By doing so, the virtual machine integrated backup manager may receive notifications of changes to data of the virtual machine.

In step 504, the initial data map is continuously updated based upon the monitoring of the data of step 502 to obtain the data map. As the virtual machine integrated backup manager receives change notifications from the operating system, the virtual machine integrated backup manager may modify the initial data map to reflect those changes to the data. Consequently, the resulting data map may be an index of the data of the virtual machine that hosts the virtual machine integrated data manager. The data map may also include any quantity and/or type of metadata regarding the indexed data of the virtual machine. Such data may be added, removed, and/or modified as the virtual machine integrated backup manager updates the initial data map.

In step 506, a request for a backup of the portion of the data of the virtual machine is obtained.

In one or more embodiments of the invention, the request is obtained from a remote agent. The remote agent may send a request in accordance with a schedule for generation of backups of the portion of the data.

In one or more embodiments of the invention, the portion of the data is application data associated with an application hosted by the virtual machine. In one or more embodiments of the invention, the portion of the data is all of the data of the virtual machine.

In step 508, the backup and the data map is provided in response to the request (e.g., step 506) for the backup. The backup may also be provided in response to request.

The method may end following step 508.

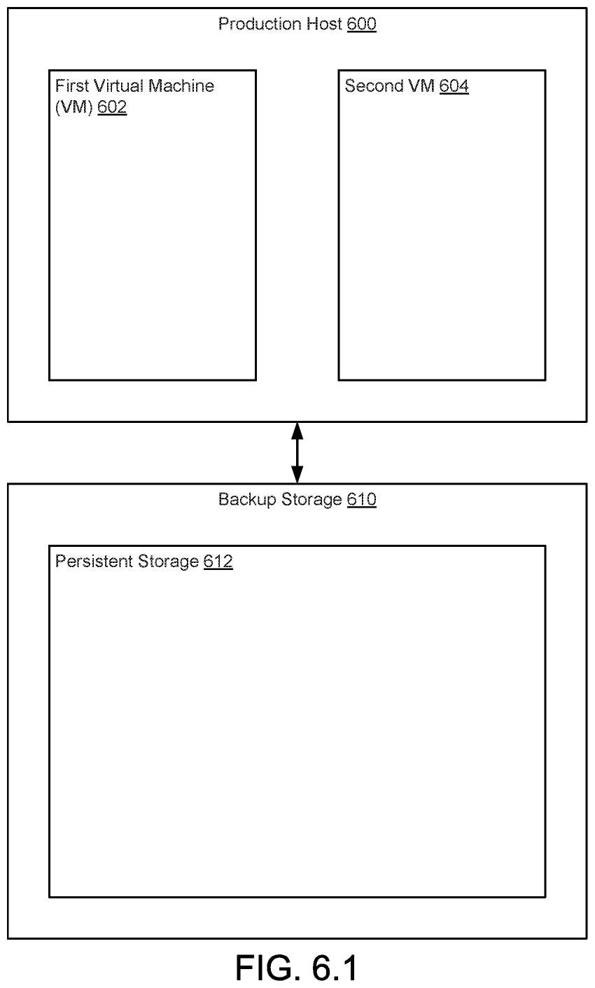

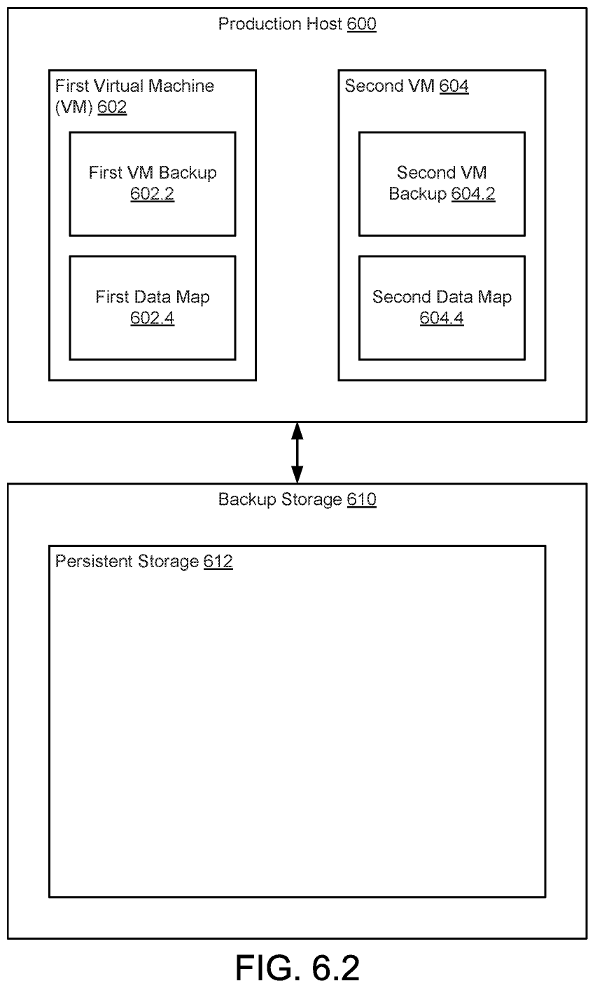

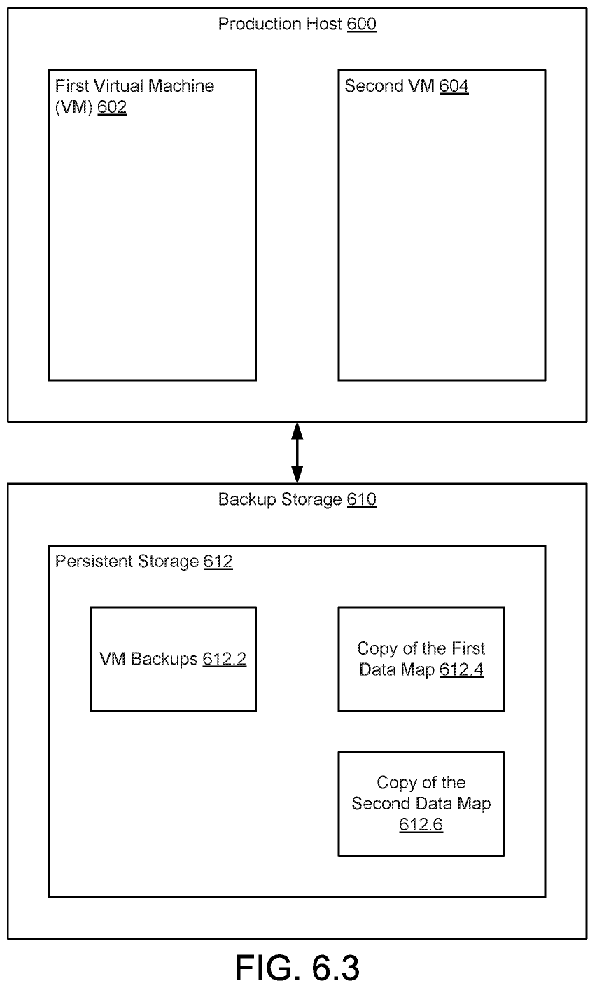

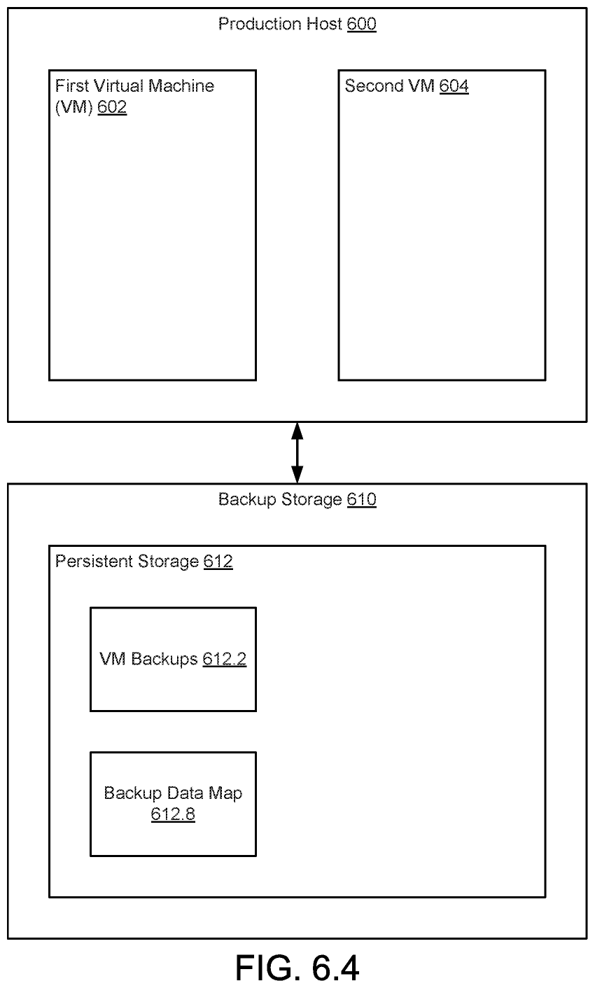

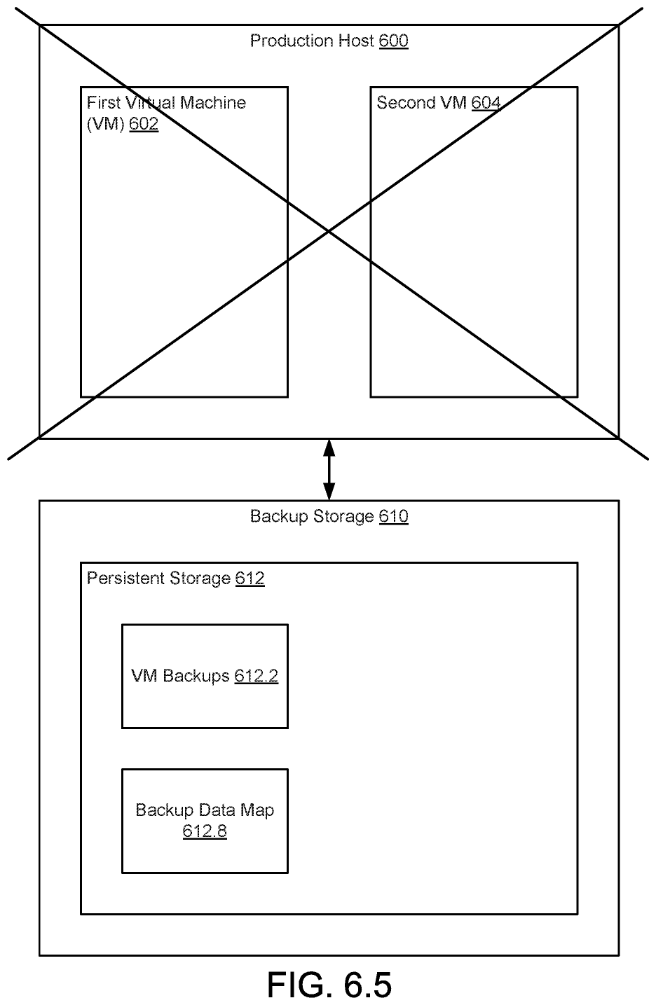

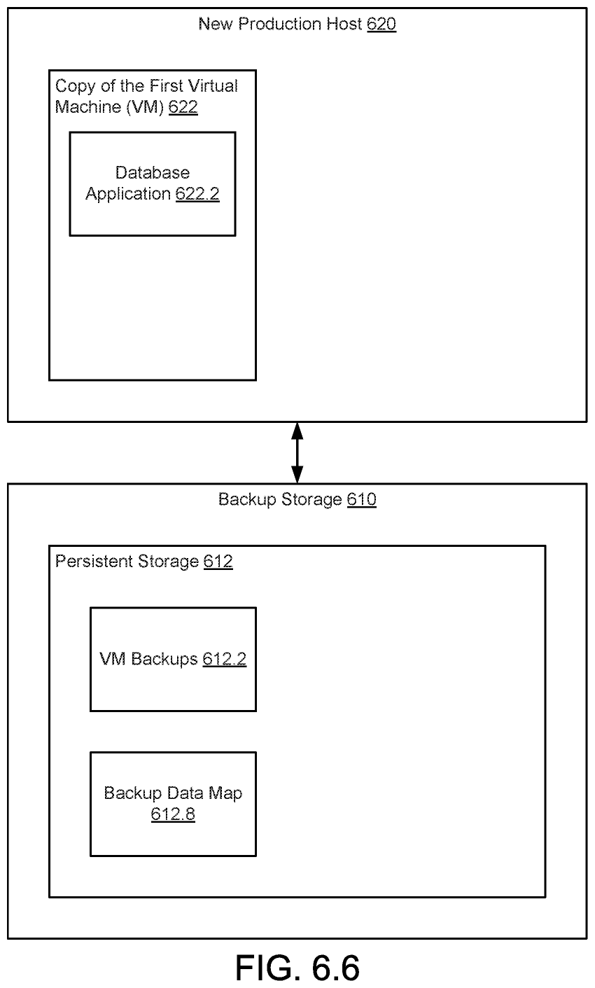

To further clarify embodiments of the invention, a non-limiting example is provided in FIGS. 6.1-6.6. Each of these figures may illustrate a system similar to that illustrated in FIG. 1 at different points in times. For the sake of brevity, only a limited number of components of the system of FIG. 1 are illustrated in each of FIGS. 6.1-6.6.

### Example

Consider a scenario as illustrated in FIG. 6.1 in which a backup storage (610) is providing data protection services for a production host (600). At the point in time illustrated in FIG. 6.1, the production host (600) hosts a first virtual machine (602) and a second virtual machine (604). The first virtual machine (602) hosts a database application and the second virtual machine (604) hosts electronic communication application. Such applications generate data that is relevant to the user.

To provide data protection services to the production host (600), a first virtual machine backup (602.2) is generated for the database application and a second virtual machine backup (604.2) is generated for electronic communication application is illustrated in FIG. 6.2. Additionally, a first data map (602.4) associated with the first virtual machine backup (602.2) is generated. Similarly, a second data map (604.4) associated with the second virtual machine backup (604.2) is also generated.

After generating the aforementioned data structures, the data structures are sent to the backup storage (610) for storage as illustrated in FIG. 6.3. Upon receipt of the data structures, the backups are stored in persistent storage (612) as part of the virtual machine backups (612.2). As discussed with respect to FIG. 1, the backups may be stored in a format that makes it computationally expensive to search the virtual machine backups (612.2) directly. The data maps are stored as a copy of the first data map (612.4) and the copy of the second data map (612.6) in the persistent storage (612).

To provide search functionality for the backups, the backup storage (610) generates a backup data map (612.8) as shown in FIG. 6.4. The backup data map (612.8) is generated based on the copy of the first data map (612.4) and the copy of the second data map (612.6). The state illustrated in FIG. 6.4, the data included in the virtual machine backups (612.2) is searchable using the backup data map (612.8).

After generating the backup data map (612.8), the production host (600) fails as illustrated in FIG. 6.5. Failure of the production host (600) prevents users from obtaining database services that are being provided by the first virtual machine (602). In response to the failure of the production host (600), the user sends request to the backup storage (610) for data associated with the database from which the user was obtained services.

In response, the backup storage (610) searches the virtual machine backups (612.2) using the backup data map (612.8) by using the name of the database as a key for the index included in the backup data map (612.8). Based on the search, the backup storage (610) reports to the user that the first virtual machine (602) has relevant data. Specifically, the backup storage (610) notifies the user that the first virtual machine (602) may be restored to a state that would enable the user to obtain access to the desired data.

Based on the information provided by the backup storage (610), the user sends a request to a remote agent (not shown) for restoration of the first virtual machine (602). In response to the request, the remote agent orchestrates restoration of the first virtual machine in a new production host (620) as illustrated in FIG. 6.6. Specifically, a copy of the first virtual machine (622) is instantiated using the virtual machine backups (612.2). The instantiated copy of the first virtual machine (622) hosts a database application (622.2). The database application (622.2) includes data upon which the user based the search request. After instantiation, the database application (622.2) provides database services to the user which enables the user to access the desired data.

End of Example

As seen from FIGS. 6.1-6.6, embodiments of the invention may provide a computationally efficient method of searching backup data that is not stored in a natively searchable format. By doing so, the computational cost for determining the location of data within the backup data may be reduced when compared to methods that require crawling of the backup data.

Any of the components of FIG. 1 may be implemented as distributed computing devices. As used herein, a distributed computing device refers to functionality provided by a logical device that utilizes the computing resources of one or more separate and/or distinct computing devices. As discussed above, embodiments of the invention may be implemented using computing devices. FIG. 7 shows a diagram of a computing device in accordance with one or more embodiments of the invention. The computing device (700) may include one or more computer processors (702), non-persistent storage (704) (e.g., volatile memory, such as random access memory (RAM), cache memory), persistent storage (706) (e.g., a hard disk, an optical drive such as a compact disk (CD) drive or digital versatile disk (DVD) drive, a flash memory, etc.), a communication interface (712) (e.g., Bluetooth interface, infrared interface, network interface, optical interface, etc.), input devices (710), output devices (708), and numerous other elements (not shown) and functionalities. Each of these components is described below.

In one embodiment of the invention, the computer processor(s) (702) may be an integrated circuit for processing instructions. For example, the computer processor(s) may be one or more cores or micro-cores of a processor. The computing device (700) may also include one or more input devices (710), such as a touchscreen, keyboard, mouse, microphone, touchpad, electronic pen, or any other type of input device. Further, the communication interface (712) may include an integrated circuit for connecting the computing device (700) to a network (not shown) (e.g., a local area network (LAN), a wide area network (WAN) such as the Internet, mobile network, or any other type of network) and/or to another device, such as another computing device.

In one embodiment of the invention, the computing device (700) may include one or more output devices (708), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (702), non-persistent storage (704), and persistent storage (706). Many different types of computing devices exist, and the aforementioned input and output device(s) may take other forms.

Embodiments of the invention may provide a computationally efficient method of accessing data stored in a format that does not facilitate native searching. For example, to improve the efficiency a storage space use, data may be stored in format that is not natively searchable. Embodiments of the invention may provide for method of generating data maps of disparate portions of the backup data prior to storage of the backup data in the format that does not facilitate native searching. By doing so, the backup data map may be generated that facilitates searching of the backup data without requiring crawling of the backup data.

Thus, embodiments of the invention may address the problem of searching data that is not natively searchable. By generating data maps without crawling the data in the non-natively searchable format, efficient search functionality may be provided.

The problems discussed above should be understood as being examples of problems solved by embodiments of the invention disclosed herein and the invention should not be limited to solving the same/similar problems. The disclosed invention is broadly applicable to address a range of problems beyond those discussed herein.

One or more embodiments of the invention may be implemented using instructions executed by one or more processors of the data management device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A backup storage, comprising:
a persistent storage for storing:
backups of entities, and
a backup data map; and
a backup manager programmed to:
obtain a search request for data;
obtain at least two data maps associated with at least two of the entities;
generate the backup data map using the at least two data maps;
search the backups for the data using the backup data map to identify a copy of the data; and
provide the copy of the data in response to the search request.

2. The backup storage of claim 1, wherein generating the backup data map using the at least two data maps comprises:
instantiating a virtual machine (VM) integrated backup manager in a VM associated with one of the at least two entities;
generating one of the at least two data maps using the VM integrated backup manager;
generating a backup for the VM; and
generating a backup data package comprising the backup and the one of the at least two data maps.

3. The backup storage of claim 2, wherein generating the one of the at least two data maps using the VM integrated backup manager comprises:
crawling data of the VM associated with the one of the at least two entities prior to generating the backup for the VM to obtain an initial data map;
registering with an operating system of the VM associated with the one of the at least two entities after generating the initial data map for change operations to monitor the data of the VM associated with the one of the at least two entities; and
updating the initial data map continuously based on the monitoring of the data of the VM associated with the one of the at least two entities to obtain the one of the at least two data maps.

4. The backup storage of claim 1, wherein generating the backup data map using the at least two data maps comprises:
indexing a portion of the backups using the at least two data maps to obtain indexed backups without using the backups.

5. The backup storage of claim 4, wherein searching the backups for the data using the backup data map to identify the copy of the data comprises:
identifying a portion of a backup of the backups associated with the data based on the indexed portion of the backups.

6. The backup storage of claim 1, wherein the backups of the entities are stored in an unindexed format, wherein the entities are virtual machines.

7. The backup storage of claim 1, wherein the backup data map is an index of all portions of data of the backups, wherein the backup data map associates each portion of the data of the backups with at least one application of a plurality of applications of the entities.

8. A method for searching backups of entities using a backup data map, comprising:
obtaining a search request for data;
obtaining at least two data maps associated with at least two of the entities;
generating the backup data map using the at least two data maps;
searching the backups for the data using the backup data map to identify a copy of the data; and
providing the copy of the data in response to the search request.

9. The method of claim 8, wherein generating the backup data map using the at least two data maps comprises:
instantiating a virtual machine (VM) integrated backup manager in a VM associated with one of the at least two entities;
generating one of the at least two data maps using the VM integrated backup manager;
generating a backup for the VM; and
generating a backup data package comprising the backup and the one of the at least two data maps.

10. The method of claim 9, wherein generating the one of the at least two data maps using the VM integrated backup manager comprises:
crawling data of the VM associated with the one of the at least two entities prior to generating the backup for the VM to obtain an initial data map;
registering with an operating system of the VM associated with the one of the at least two entities after generating the initial data map for change operations to monitor the data of the VM associated with the one of the at least two entities; and
updating the initial data map continuously based on the monitoring of the data of the VM associated with the one of the at least two entities to obtain the one of the at least two data maps.

11. The method of claim 8, wherein generating the backup data map using the at least two data maps comprises:
indexing a portion of the backups using the at least two data maps to obtain indexed backups without using the backups.

12. The method of claim 11, wherein searching the backups for the data using the backup data map to identify the copy of the data comprises:
identifying a portion of a backup of the backups associated with the data based on the indexed portion of the backups.

13. The method of claim 8, wherein the backups of the entities are stored in an unindexed format, wherein the entities are virtual machines.

14. The method of claim 8, wherein the backup data map is an index of all portions of data of the backups, wherein the backup data map associates each portion of the data of the backups with at least one application of a plurality of applications of the entities.

15. A non-transitory computer readable medium comprising computer readable program code, which when executed by a computer processor enables the computer processor to perform a method for searching backups of entities using a backup data map, the method comprising:
obtaining a search request for data;
obtaining at least two data maps associated with at least two of the entities;
generating the backup data map using the at least two data maps;
searching the backups for the data using the backup data map to identify a copy of the data; and
providing the copy of the data in response to the search request.

16. The non-transitory computer readable medium of claim 15, wherein generating the backup data map using the at least two data maps comprises:
instantiating a virtual machine (VM) integrated backup manager in a VM associated with one of the at least two entities;
generating one of the at least two data maps using the VM integrated backup manager;
generating a backup for the VM; and
generating a backup data package comprising the backup and the one of the at least two data maps.

17. The non-transitory computer readable medium of claim 16, wherein generating the one of the at least two data maps using the VM integrated backup manager comprises:
crawling data of the VM associated with the one of the at least two entities prior to generating the backup for the VM to obtain an initial data map;
registering with an operating system of the VM associated with the one of the at least two entities after generating the initial data map for change operations to monitor the data of the VM associated with the one of the at least two entities; and
updating the initial data map continuously based on the monitoring of the data of the VM associated with the one of the at least two entities to obtain the one of the at least two data maps.

18. The non-transitory computer readable medium of claim 15, wherein generating the backup data map using the at least two data maps comprises:
indexing a portion of the backups using the at least two data maps to obtain indexed backups without using the backups.

19. The non-transitory computer readable medium of claim 18, wherein searching the backups for the data using the backup data map to identify the copy of the data comprises:
identifying a portion of a backup of the backups associated with the data based on the indexed portion of the backups.

20. The non-transitory computer readable medium of claim 15, wherein the backups of the entities are stored in an unindexed format, wherein the entities are virtual machines.
